(19) United States
(12) Patent Application Publication
(10) Pub. No.: US 2015/0278820 A1
(43) Pub. Date: Oct. 1, 2015

(54) SYSTEMS AND METHODS FOR EXECUTING CRYPTOGRAPHICALLY SECURE TRANSACTIONS USING VOICE AND NATURAL LANGUAGE PROCESSING

(71) Applicant: Mark Stephen Meadows, Emeryville, CA (US)

(72) Inventor: Mark Stephen Meadows, Emeryville, CA (US)

(21) Appl. No.: 14/668,882

(22) Filed: Mar. 25, 2015

Related U.S. Application Data
(60) Provisional application No. 61/970,167, filed on Mar. 25, 2014.

(51) Int. Cl. G06Q 20/40; G06Q 20/38; G06F 17/28; G06F 17/30; G06Q 20/06

(52) U.S. Cl. CPC G06Q 20/40145; G06F 17/30879; G06Q 20/065; G06F 17/28; G06Q 20/3821; G06Q 2220/00

(57) ABSTRACT

A method for executing cryptographically secure transactions using voice and natural language processing is provided. The method comprises executing on a processor the steps of receiving an electronic communication in a computer terminal with a memory module, an authentication module, a parsing module, a digital-to-analog converter, a voice interface module and a ledger module, the electronic communication is a verbal request by a user initiating a cryptographically secure transaction for a commodity of exchange in the form of an audio frequency signal; transforming the audio frequency signal into a digital signal; authenticating the user using the authentication module; parsing the digital signal using the parsing module to identify an intent of the verbal request by the user; determining the intent of the verbal request matches an intent of the computer terminal; and transmitting the commodity of exchange upon confirmation of the intent of the verbal request matching the intent of the computer terminal.

### CLAIM OF PRIORITY UNDER 35 U.S.C. §119

The present Application for Patent claims priority to U.S. Provisional Application No. 61/970,167 entitled “SYSTEMS AND METHODS FOR EXECUTING FINANCIAL TRANSACTIONS USING METHODS OF NATURAL LANGUAGE PROCESSING”, filed Mar. 25, 2014, and hereby expressly incorporated by reference herein.

### FIELD

The present application relates to financial transactions, and more particularly, to systems and methods for executing cryptographically secure transactions using methods of natural language processing.

### BACKGROUND

Electronic commerce, commonly known as e-commerce, allows the buying and selling of products, information, or services (previously unavailable and unknown from the pre-Internet world) via electronic systems such as the Internet and other computer networks. These systems exist both on the Internet and at Points of Sale (or POS). As the Internet and mobile telecommunications have grown there has been a corresponding reduction in the time needed to perform transactions. Some systems have been built that facilitate credit transactions via established companies and banking systems used today. But these present problem in terms of convenience, efficiency and network functionality.

The convenience of using these systems is a challenge as there is a need for both buyers and sellers to not only interface their banking system with the payment or transaction layer, but to conduct the transaction in a manner that suits the current systems of today. Inputting a sixteen-digit number, even via swipe or scan hardware methods, and adding in the additional verification code or Personal Identification Number (PIN), then, sometimes, a signature as well, leaves room for errors and can take a long time, such as in taxis, and is rarely used for smaller transactions, such as buying a coke at a vending machine.

As well as being inconveniently slow, monetary exchanges, or other commodity exchanges (such as shares or stock exchanges), are currently complicated and largely unsuited to electronic transactions. Cash is impossible and even credit card systems, for example, require the Seller to authorize the Buyer's card via a centralized transaction service, thus engaging in a manual transaction method that requires entering the card number and authorizing the transaction on behalf of the Buyer. The networks that ecommerce systems use today require both parties to be members of the same network, which presents difficulties if a payer of the system is a member and the payee is not. There are solutions for this, but those solutions require interfacing multiple systems which can introduce security risks as well as increasing both payment speed and transaction fees. Other problems include refunds, confidence in the store, reliability of the transfer, charge-backs, and especially the fees and time associated with the transaction, which are far higher than necessary because the credit card systems, stock exchange systems, and contracting systems were all invented prior to, and never initially intended for, use across networked computer systems.

The above problems are not the case with a system that relies upon Natural Language interface and distributed ledger or crypto-currency systems. These were specifically designed for the exchange of valuable commodities over computer networks and can be used to great benefit for online e-commerce transactions. Digital transactions that rest on the distributed ledger or cryptographic transfer provide great promise for solving these problems. By coupling this technology with Natural Language interface the matters of convenience, speed, and even cost are amplified, allowing a verified financial transaction to be completed in under a second with a statement as simple as, “I′d like a Coke®,” or “I′d like to purchase ten shares of Acme corporation,” or “Take me to Grand Central Station.”

### SUMMARY

The following presents a simplified summary of one or more implementations in order to provide a basic understanding of some implementations. This summary is not an extensive overview of all contemplated implementations, and is intended to neither identify key or critical elements of all implementations nor delineate the scope of any or all implementations. Its sole purpose is to present some concepts or examples of one or more implementations in a simplified form as a prelude to the more detailed description that is presented later.

Various aspects of the disclosure provide for a computer implemented method for executing cryptographically secure transactions using voice and natural language processing. The method comprises executing on a processor the steps of receiving an electronic communication in a computer terminal with a memory module, an authentication module, a parsing module, a digital-to-analog converter, a voice interface module and a ledger module, the electronic communication is a verbal request by a user initiating a cryptographically secure transaction for a commodity of exchange in the form of an audio frequency signal; transforming the audio frequency signal into a digital signal using the analog-to-digital converter of the computer terminal; authenticating the user using the authentication module of the computer; parsing the digital signal using the parsing module of the computer terminal to identify an intent of the verbal request by the user; determining the intent of the verbal request matches an intent of the computer terminal; and transmitting the commodity of exchange upon confirmation of the intent of the verbal request matching the intent of the computer terminal. The commodity of exchange is selected from at least one of a good, service and a digital currency.

According to one feature, the method further includes executing on the processor the step of exchanging a digital currency using a ledger module of the computer terminal to complete the cryptographically secure transaction.

According to another feature, the method further includes executing on the processor the step of generating a receipt of the completed cryptographically secure transaction in the form of a barcode where the barcode is transmitted from the computer terminal to a mobile device of the user. The receipt may be a QR Code.

According to yet another feature, the user may be authenticated using voice recognition.

According to yet another feature, determining the intent of the verbal request comprises extracting dialogue elements from the verbal request using the parsing module; and analyzing the dialogue elements as a relational group of vectors to generate reports of emotional content and affect. The dialog elements may be derived from at least of semantic elements, biometric elements and cultural elements.

A non-transitory computer-readable medium with instructions stored thereon, that when executed by a processor, perform the steps comprising receiving an electronic communication in a computer terminal with a memory module, an authentication module, a parsing module, a digital-to-analog converter, a voice interface module and a ledger module, the electronic communication is a verbal request by a user initiating a cryptographically secure transaction for a commodity of exchange in the form of an audio frequency signal; transforming the audio frequency signal into a digital signal using the analog-to-digital converter of the computer terminal; authenticating the user using the authentication module of the computer terminal; parsing the digital signal using the parsing module of the computer terminal to identify an intent of the verbal request by the user; determining the intent of the verbal request matches an intent of the computer terminal; and transmitting the commodity of exchange upon confirmation of the intent of the verbal request matching the intent of the computer terminal.

According to one feature, the non-transitory computer-readable medium with instructions stored thereon, that when executed by a processor, further performs the step of exchanging a digital currency using a ledger module of the computer terminal to complete the cryptographically secure transaction.

According to another feature, the non-transitory computer-readable medium with instructions stored thereon, that when executed by a processor, further performs the step of generating a receipt of the completed cryptographically secure transaction in the form of a barcode where the barcode is transmitted from the computer terminal to a mobile device of the user.

According to yet another feature, determining the intent of the verbal request comprises extracting dialogue elements from the verbal request using the parsing module; and analyzing the dialogue elements as a relational group of vectors to generate reports of emotional content and affect. The dialog elements may be derived from at least one of semantic elements, biometric elements and cultural elements.

In one aspect, the disclosure provides a computer terminal for executing cryptographically secure transactions using voice and natural language processing. The terminal comprises a processing circuit; a communications interface communicatively coupled to the processing circuit for transmitting and receiving information; and a memory communicatively coupled to the processing circuit for storing information. The processing circuit is configured to receive an electronic communication into a voice interface module within the processing circuit, the electronic communication is a verbal request by the user initiating a cryptographically secure transaction for a commodity of exchange in the form of an audio frequency signal; transform the audio frequency signal into a digital signal using an analog-to-digital converter communicatively coupled to the processing circuit; authenticate the user using an authentication module within the processing circuit; parse the digital signal using a parsing module within the processing circuit to identify an intent of the verbal request by the user; determine the intent of the verbal request matches an intent of the computer terminal; and transmit the commodity of exchange upon confirmation of the intent of the verbal request matching the intent of the computer terminal. The commodity of exchange may be selected from at least one of a good, service and a digital currency.

According to one feature, the processing circuit of the computer terminal is further configured to exchange a digital currency using a ledger module within the processing circuit to complete the cryptographically secure transaction.

According to another feature, the processing circuit of the computer terminal is further configured to generate a receipt of the completed cryptographically secure transaction in the form of a barcode where the barcode is transmitted from the computer terminal to a mobile device of the user. The receipt may be a QR code.

According to yet another feature, determining the intent of the verbal request comprises extracting dialogue elements from the verbal request using the parsing module; and analyzing the dialogue elements as a relational group of vectors to generate reports of emotional content and affect. The dialog elements may be derived from at least one of semantic elements, biometric elements and cultural elements.

### BRIEF DESCRIPTION OF THE DRAWINGS

FIG. 1 illustrates an example of a networked computing platform utilized in accordance with an exemplary embodiment.

FIG. 2 illustrates a flow chart illustrating of a method of executing a financial transaction, in accordance with an exemplary embodiment.

FIG. 3 illustrates an example of a distributed ledger cryptocurrency network utilized in accordance with an exemplary embodiment.

FIG. 4 is a diagram illustrating an example of a hardware implementation for a terminal configured to execute cryptographically secure transactions using voice and natural language processing.

FIG. 5 is a flow chart illustrating a computer implemented method for executing cryptographically secure transactions for a commodity of exchange using voice and natural language processing.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

In the following description, specific details are given to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, structures and techniques may be shown in detail in order not to obscure the embodiments.

The term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise. The word “exemplary” is used herein to mean “serving as an example, instance, or illustration.” Any implementation or embodiment described herein as “exemplary” is not necessarily to be construed as preferred or advantageous over other embodiments or implementations. Likewise, the term “embodiments” does not require that all embodiments include the discussed feature, advantage or mode of operation.

The term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another, even if they do not directly physically touch each other.

The terms “commodity of exchange”, “commodity exchange”, “unit of data”, “unit of value” and “measurement of value” may refer to any type of currency, goods, services and/or information that can be exchanged in a transaction. The term “currency” may refer to money in any form when in actual use or circulation, including but not limited to banknotes, coins and an electronically created and stored medium of exchange (e.g. digital currency). The term “crypto-currency” may refer to any type of digital currency. The term “ledger” may refer to a principal book or computer file for recording and totaling commodity of exchange transactions by account, with debits and credits in separate columns and a beginning balance and ending balance for each account.

The terms “terminal”, “access terminal”, “computer terminal”, “seller” and “programming” as used herein are meant to be interpreted broadly. For example, an “access terminal” refers generally to one or more devices that communicate with one or more other devices through wireless signals. Such access terminals may also be referred to by those skilled in the art as a user equipment (UE), a mobile station (MS), a subscriber station, a mobile unit, a subscriber unit, a wireless unit, a remote unit, a mobile device, a wireless device, a wireless communications device, a remote device, a mobile subscriber station, a mobile terminal, a wireless terminal, a remote terminal, a handset, a terminal, a user agent, a mobile client, a client, or some other suitable terminology. Access terminals may include mobile terminals and/or at least substantially fixed terminals. Examples of access terminals include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, and/or other communication/computing devices which communicate, at least partially, through a wireless or cellular network. The term “terminal” may also refer to any object or device where a financial transaction may occur. For example, “a terminal” may include but is not limited to a vending machine, a car, a medical device or any other electronic point of sale.

The term “cultural computing” may refer to the notion that cultural cues can be used to determine intention, just as emotional or semantic cues.

The term “blockchain” may refer to a public ledger that records peer-to-peer digital currency transactions such as Bitcoin transactions.

The term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The various concepts presented throughout this disclosure may be implemented across a broad variety of telecommunication systems, network architectures, and communication standards.

Throughout this disclosure, use of the term “user” designates any user specifying any type of good, service or information, including but not limited to a buyer and a consumer; user of the term “provider” encompasses any entity such as sellers or distributors, offering any good, service or information, for any reason including but not limited to purchase, distribution, rent or otherwise.

Throughout this disclosure, the use of the terminology “connected system” may refer to audio sensors, mobile devices, phones, tablets, vending machines, robots, smart-homes, parking meters, smart cities and the like.

Throughout this disclosure, use of the terms “financial instruments”, “records” and “models” may refer to, but is not limited to, currency, private equities, public equities, bonds, derivatives (e.g. futures, forwards, swaps, options and more complex variations), voting rights associated with any of the above, commodities, spending records, trading records, mortgage/loan records, servicing records, crowd-funding, micro-finance, and micro-charity.

Throughout this disclosure, use of the term “public records” may refer to, but is not limited to, land titles, vehicle registrations, business licenses, business formation/dissolution records, business ownership records, regulatory records, criminal record, passports, birth certificates, death certificates, voter IDs, voting, health/safety Inspections, building permits, gun permits, forensic evidence, court records, voting records, non-profit organization records, and government/non-profit accounting/transparency

Throughout this disclosure, use of the term “private records” may refer to, but is not limited to, contracts, signatures, wills, trusts, escrows, and global positioning satellite (GPS) trails (personal).

Throughout this disclosure, use of the term “semi-public records” may refer to, but is not limited to, educational degrees, educational certifications, professional certifications, learning outcomes, grades, human resource records (e.g. salaries, performance reviews, accomplishments), medical records, accounting records, business transaction records, genome data, GPS trails (institutional), delivery records, and arbitration records.

Throughout this disclosure, use of the term “physical asset keys” may refer to, but is not limited to, home/apartment keys, vacation home/timeshare keys, hotel room keys, car keys, rental car keys, leased car keys, locker keys, safety deposit box keys, package deliveries (split key between delivery firm and receiver), betting records, and fantasy sports records.

Throughout this disclosure, use of the term “intangibles” may refer to, but is not limited to, coupons, vouchers, reservations (e.g. restaurant, hotels, queues, etc.), movie tickets, patents, copyrights, trademarks, software licenses, video game licenses, music/movie/book licenses (DRM), domain names, online identities, proof of authorship, and proof or prior art.

Other possible commodities may include, but are not limited to, documentary records (e.g. photos, audio, and video), data records (e.g. sports scores, temperature, etc.), a subscriber identity module (SIM) card, GPS network identity, gun lock codes, weapons unlock codes, nuclear launch codes, and spam control (micro-payments for posting).

### Overview

Natural Language dialogue elements may be used to initiate and complete electronic transactions of value and ownership exchange. The dialog elements from either a Seller or a Buyer, or multiple sellers or buyers, may be generated via text, gesture, and/or spoken language, and the identities of the parties may be verified. The transaction may be initiated by a semantic, cultural computing, or biometric parsing module which determines either party's intention, grammatical mood, and other qualities associated with the anticipated transaction. The system may then confirm that the Buyer's intention corresponds with the Seller's intention for the purchase of information, goods, services, money, or ownership of other item of value previously represented in the ledger. A transfer of the commodity is made via a private key, associated with an authenticated identity, which is used to sign the transaction. The transaction is verified and the ledger is updated by clients within a peer-to-peer network. For example, a Buyer may walk up to a vending machine and say “I'd like a Coke®,” and the system which may receive this verbal communication in the form of an analog audio signal, from a microphone for example, which may then be transformed or converted into a digital signal by an analog-to-digital converter connected to a processing circuit into. The digital signal may then be analyzed by the processing circuit and determined to be an intent to purchase an item from the vending machine. The vending machine may confirm the purchase with the Buyer by displaying a message on a display on the vending machine or an announcement relayed through a speaker connected to the processing circuit within the vending machine. Simultaneously, the vending machine may also directly deliver the good to the Buyer. The shared ledgers of the Buyer, Seller and other members of the peer-to-peer network would then be updated accordingly. Compared to purchasing systems today that use neither networked ledgers, such as crypto-currencies, or Natural Language Processing systems, enabling a program to dynamically perform commercial transactions would increase the ease, effectiveness, and simplicity of purchasing decisions while simultaneously reducing the costs that most stores bear today.

According to one aspect, the consumer/buyer may initiate an electronic transaction by speaking into a microphone or any other type of voice detection device, such as a membrane, known in the art, within a terminal. The voice detection device may receive the audio in the form of an analog signal which may then be converted to a digital signal within the network. The consumer/buyer may be pre-authenticated with the terminal so that the terminal can authenticate the consumer/buyer using voice recognition methods known in the art. Alternatively, the consumer/buyer may be authenticated using a terminal, such as cell phone, mobile phone or any other type of hand-held device, wearable computing device, or other communication/computing device which communicates, at least partially, through a wired, wireless or cellular network. Furthermore, the terminal or device may have a unique identifier that identifies the terminal or device as unique and allows the terminal or device to be authenticated and verified by its owner over a wired, wireless and/or cellular network. Authentication methods may include, but are not limited to, verification using hand scanners, retina scanners, and vocal patterns that can be used to verify an identity or any other type of device or mechanism used for authentication as known in the art. The authentication methods may be used to ensure that all transactions made are authorized both at the client and transaction layers in the peer-to-peer network. At the client layer in the peer-to-peer network, a User ID, a Client ID, or other identification method may be employed to ensure that the person (user/consumer/buyer) or entity making the transaction is authenticated and also verified by the computing device that represents them to the local network(s). At the transaction layer in the peer-to-peer network, cryptocurrencies may deliver secure encryption functions that ensure the blockchain transaction is authenticated. Additional methods may be employed, based on client-side implementation, to minimize the risk of replay attacks, such as a Coordinated Universal Time (UTC) timestamp of the transaction or hashing salts, or other methods that employ additional security layers.

Upon authenticating the consumer/buyer, the speech in the form of an audio frequency signal, or audio signal, may be converted into a digital signal and displayed as text. The text may then be parsed using a parsing module in the processing circuit of the terminal to identify the intent of the consumer/buyer. A buyer might say, for example, “I would like to buy a Coke®,” which can identify intent (in this instance the conditional form, would, gets understood by the system as a part of speech of the verb, “like” signaling intention alongside other possible phrasing of the intention (such as “want,” “need,” “give,” or any of a large range of other possibilities). Another example might be if someone making an in-app purchase, such as “I want to upgrade” or if someone is making a hardware upgrade purchase, such as heated seats in a car, saying “I would like to buy the option for heated seats.” In this last instance, much like in the in-app purchase, hardware feature sets are unlocked once the intention to purchase has been signaled by the user. Once the intent of the consumer/buyer has been established, the terminal may request the consumer/buyer confirm the transaction. For example, the system may respond, with natural language, “You would like to purchase X?”, where “X” is a feature, product, service, or other commodity addressed as the object or subject of the intention to buy).

When the transaction is confirmed, payment may be provided by the consumer/buyer in the form of a commodity of exchange. For example, the commodity of exchange may be digital currency which is tracked using a ledger associated with the consumer/buyer.

The disintermediation of a central authority, such as a bank or credit card company, means that not only that financial transactions of a currency (such as the dollar or euro) may be facilitated, but other transactions of value as well. This basic voice-driven interface may allow transactions in which one party is exchanging one unit(s) or measurement of value for another unit(s) or measurement of value via this commodity of exchange. These may be represented electronically as coupons, tickets, licenses, or micro-payments. Many technical systems for such transactions already exist in the blockchain protocol as well as in open-source projects such as ColoredCoins, CoinPrism, CounterParty, Ethereum, MaidSafe, and other standards that allow the sub-tracking and processing of cryptocurrency units on the blockchain and the subsequent transfer to QR codes or other means of later point-of-sale redemption. These methods may be accessed both by Application Programming Interfaces (APIs), by applications on an existing framework, or by a discrete and private cryptocurrency method specifically designed for that coupon, voucher, ticket, license or micropayment. Coupons, tickets, licenses and micropayments, or any other representation of time-delayed value, may be initiated, agreed upon, and transferred because they are a virtual representation of value and a record of permission. There are great benefits to this as it eliminates the possibility of counterfeiting.

Coupons

With regard to coupons, vouchers, or other representation of time-delayed values, these may be initiated, agreed upon, and electronically transferred between devices (for example a mobile device and a terminal) as they are a virtual representation of value. Coupons may be a record of permission.

For example, a terminal, such as a vending machine, may broadcast an audio signal or text stating “Since you have purchased a Coke®, would you like a discount for a six-pack at the grocery store near you?” The conversant/consumer/buyer, using the same methods and technical architecture for a transaction described herein, may accept the discount or other offer by using a command (for example a voice command, gesture or text) which is received by the terminal in the form of an audio signal via a microphone in or near the terminal (for example) or motion in the form of a gesture via a camera in or near the terminal (for example). This command (or electronic communication) is received by the microphone or camera, for example, and transformed by a processor or processing circuit in the terminal into a digital signal. The digital signal is parsed using a parsing module in the processing circuit of the terminal, as described in further detail below to determine the intent of the conversant/consumer/buyer. Once the intent of acceptance is determined by the parsing module, the terminal may transmit the appropriate currency using a ledger module of the processing circuit as described in further detail below. Alternatively, the conversant/consumer/buyer may deny or refuse the discount or other offer using a command and the terminal interprets the command as described above.

According to another example, the conversant/consumer/buyer may inquire if there “Are there any hot deals today?” by using issuing command (such as an audio command, gesture or text) to the terminal. The terminal may transform and interpret this command as described above and search its database to identify any relational links and respond with, “Since you like Coca-Cola® so much McDonald's® has a discount for fries and a Coke® that's valid until 5 pm tonight. Are you interested in that one?”

In the examples provided above with respect to coupons, the transaction may be recorded on the blockchain, as described below and as is known in the art, for later redemption. This may be similar to a printed coupon, or other voucher for later redemption, however, instead of receiving a printable or physical ticket a cryptocurrency unit that verifies the conversant/consumer/buyer has accepted these coupons from the Seller, via the terminal, and is registered among the client nodes of the blockchain. That cryptocurrency unit may be transferred to a QR code or some other method that allows access to discounts and other rights and privileges associated with later purchases. As with the original transaction, and as coupons and vouchers may or may not be transferred today, the cryptocurrency unit may or may not be transferable. Such integrated services and applications will allow many people to buy and store a wide array of goods on the blockchain.

More importantly, Assurance Contracts may also be employed in a very similar method of a simple coupon or voucher, by simply asking and engaging in dialogue with the terminal. In this case, if a predetermined number of people (conversant/consumer/buyer) agree to receive a coupon or voucher (either because they purchased it or it was offered for some other reimbursement), then the discounted measure becomes available to all of the people involved. For example a Seller may be able to reduce the price if the quantity increases above a certain point, which this mechanism allows. If the predetermined minimum is not met, the deal then expires for all parties and any monetary contributions are returned.

Traditionally the binding mechanism has been a third-party enforcement such as an escrow service, a government agency, a bank, or corporation. These third parties add to the cost and are often able to change the rules of such transactions. Blockchain provides both increased possibilities with this system or terminal (as charge-backs are impossible) and transactions, such as funds that are returned if the pool is not achieved, may be automated in the data of the cryptocurrency unit itself, or via the rules that defined the limits for that cryptocurrency unit. The complexity of the system is made simple with voice interface and simple questions and answers, such as, “If ten people contribute by tomorrow night you'll get 50% discount. Want to participate?”

Assurance Contracts (sometimes called a “multi-signature contract”) may reduce risk for retailers, who may treat vouchers or coupons as quantity discounts as well as a tool for promoting sales. Additional transactions embedded in this example may include a splitting of the cost such that the owner of the assurance contract (sometimes called a “multi-signature contract”) benefit by keeping a portion of the transaction. Alternatively, a merchant may or may not pay upfront costs to participate in this and the system may or may not save state of the end-user, or converstand/consumer/buyer, and may or may not choose to re-contact them with additional offers of Coupons and Vouchers. Furthermore, as the natural language processing systems often use inference methods that are based on past behavior and probability, the system (or terminal) may or may not employ recommendations, and even suggest against some purchases.

Tickets

With regard to tickets, or other representations of time-delayed values, these may be initiated, agreed upon, and transferred because they are a virtual representation of value. Tickets are a record of permission.

For example, the command “I would like to book two tickets to the movie, Her” or “I would like a reservation on the plane that flies to Tokyo at 4 pm on Friday the 25^{th}” are two examples of a voice-activated ticket purchase. In this case the transaction may be recorded on the blockchain for later redemption. This is similar to a printed airline ticket, or printed movie ticket, however, instead of receiving a printable or physical ticket a cryptocurrency unit that verifies the converstant/consumer/buyer has purchased these tickets from the Seller using a terminal and is registered among the client nodes of the blockchain. That cryptocurrency unit may be transferred to a QR code or some other method that allows access into the movie, concert, or other system that requires a ticket such as a plane flight, a concert, or even tickets such as given to traffic offenders. As with the original transaction, and as tickets may or may not be transferred today, the cryptocurrency unit may or may not be transferable. Such integrated services and applications may allow many people to buy and store a wide array of goods on the blockchain.

Other examples of tickets may include, but are not limited to (1) Transportation tickets, such as airlines, automobiles, trains, trams, subways, and other vehicles issued to confirm that an individual has purchased such transportation. This is a specific instance of the above example such as, “Take me to the airport”, in which a deduction is transacted based on that ticket in the taxi; (2) Lottery tickets, such as a random-pool in which a particular winner earns payout (similar to the coupons and vouchers, above); (3) Infraction tickets such as those issued for parking, speeding, or other infractions confirming that the infraction was performed based on previous rules; (4) An admission or entrance ticket used to gain admission to a location or event. These may be movies, concerts, lectures, conferences, festivals or other gatherings of people in a specific place and time that requires a certification for entry; (5) Toll collection tickets used to indicate which vehicles entered a toll system, such as a bridge or road, to charge based on an established use rate; and (6) A ticket, or file in a problem-tracking system, which documents a reported problem and the steps taken, or being taken, to resolve it.

Licenses

With regard to a license (such as software or other virtual property) or other representation of time-delayed value, these may be initiated, agreed upon, and transferred because they are a virtual representation of value. Licenses are a record of permission.

For example, “I would like to license this software for the next year” or “I would like a license to use this music in my video” or “I would like to license this videogame” are three examples of a voice-activated license purchase. In this case the transaction is recorded on the blockchain for later redemption. This is similar to a printed licensing contract, however, instead of receiving a printable or physical license a cryptocurrency unit that verifies the converstand/consumer/buyer has purchased this license from the Seller (via a terminal) and is registered among the client nodes of the blockchain. That cryptocurrency unit may be transferred to a written and signed contract, QR code, or some other method that verifies licensing rights for that virtual good. As with the original transaction, and as printed licenses may or may not be transferred today, the cryptocurrency unit may or may not be transferable. Such integrated services and applications will allow many people to buy and store a wide array of goods on the blockchain.

A license may be granted, or authorized, by a party (“Seller” or “Licensor”) to another party (“Buyer” or “Licensee”) as an agreement between those parties. This license provides the permission to use the licensed material by the “licensee” or “Buyer”. This license may be issued to allow an activity that would otherwise be forbidden, it may or may not require paying a fee and/or proving a capability and it may or may not also serve to provide information on a certain type of activity, and it may or may not provide the opportunity to set conditions and limitations. Examples may include software, intellectual property, components of use associated with a grant, including a term, territory, renewal provisions, and other limitations important to the “Licensor” or “Buyer”. These examples may be registered by a cryptocurrency unit on the blockchain. Many licenses, including books, magazines, software, services, music, games and other virtual goods, including elements and features of those licenses, are valid for a particular length of time which may also be registered by a cryptocurrency unit on the blockchain. The value of the license may or may not increase, which may or may not be linked to market conditions or other changes in external conditions. One of the benefits of such transactions using cryptocurrency units is that a fully-executed version of the agreement is implied by the verification of multiple nodes on the peer-to-peer network, as is part of the existing blockchain protocol.

Micropayments

With regard to micro-transactions, or other representation of time-delayed value, these may be initiated, agreed upon, and transferred because they are a virtual representation of value. Micropayments, micro-transactions, crowd-funding, micro-financing, and micro-lending are a record of permission.

For example, “I would like to use this Wi-Fi network” or “I would like to borrow a dollar each hour until I ask that the funding service end” are two examples of a voice-activated micropayment. In this case the transaction may be recorded on the blockchain for later reimbursement, redemption, payment, or refinancing. This is similar to a printed financing contract, however, instead of receiving a printable or physical agreement a cryptocurrency unit that verifies the Buyer has engaged in this agreement with the Seller and is registered among the client nodes of the blockchain. That cryptocurrency unit may be transferred to a written and signed contract, QR code, or some other method that verifies the agreement. As with the original transaction, and as agreements may or may not be transferred today, the cryptocurrency unit may or may not be transferable. Such integrated services and applications will allow many people to buy and store a wide array of goods on the blockchain.

### QR Code

In one configuration, the present disclosure may translate one set of date (such as Bitcoin) into another set of data (a black-and-white code such as a QR code or other type of barcode). Other barcodes may include, but are not limited to, 2D Barcodes (such as Data Matrix, PDF-417 and QR-Code), Alphanumeric Barcodes (such as Code-39, Code-93, Code-128 and GS1-128/UCC/EAN-128), UPC/EAN Barcodes (such as EAN-8, EAN-13, ISBN, ISSN, UPC-A and UPC-E), Numeric Barcodes (such as Codabar, Code-11 and MSI Plessey), Code 2 of 5 Based Barcodes (such as Code 2 of 5, Interleaved 2 of 5 and ITF-14), and Postal Barcodes (such as Identcode, Leitcode, POSTNET, PLANET, USPS Intelligent Mail Barcode (OneCode) and RM4SCC).

Throughout this disclosure, the term “barcode” or “QR code” may refer to any barcode in the group of barcodes described above or a batch of printed identifiers and a cryptocurrency unit, such as “Bitcoin”, a “darkcoin”, a “friecoin” or a “litecoin” (all various cryptocurrencies) may be used to generate a BarCode, a Postal Barcode or a QR Code (all various barcodes). Thus, any of the blockchain cryptocurrencies can be used to generate any of the various barcodes.

The Bitcoin, or other cryptocurrency, may be generated into a barcode using existing open source models such as http://bitcoingreode.info/, http://www.btcfrog.com/qr, http://www.keepdynamic.com/java-barcode/barcode/qr-code.shtml or any other well-known and existing services.

These services each allow sending dynamic requests and receiving a Portable Networks Graphic (PNG) file back, which is then the visible verification of the transaction, which may or may not be used, so it happens in just a few minutes. The Seller then simply attaches his commerce server to send the bitcoin address, which then generates a QR Code via one of these services, and then sends it back to the Seller, which then forwards to the address used to generate the transaction (The buyer's blockchain address).

For example, Bitcoin may be sent from a buyer to a seller. A peer-to-peer network verification may occur verifying the addresses are properly signed as well as confirming the verification to the network. Next the seller may receive the Bitcoin and examines the amount (for example, $1 or $1) in header of the Bitcoin (or “the cryptocurrency unit” or “the blockchain entry” as described herein). The seller may then add any additional information that would be needed, such as the identity, venue, event, plane, URL, encryption methods, or whatever data is needed for their particular service (this is up to them).

Next, an external service, such as described above, may be used or internal modules, as described below, may be used. Within this external service, the Bitcoin address may be validated and the 2^{nd} layer address and amount may be verified. QR Codes may be loaded, as is a library of supported codes (these might include Bitcoin with amount, Plain Text, URL, vCard, SMS, Email, Wi-Fi, Geo, Phone number, voice identifier, photograph or whatever data might be captured when the buy command was sent) and the new QR Code may be generated. Next, properties may be set and an image object is buffered, drawn and the QR or barcode, for example, is generated. Finally, the image may be returned to a pre-designated address, phone, or other predesignated network nodes

Additionally, this might also be a servlet via existing modules like iReport or KA.Barcode (for Java), customized QR Code or Barcode error correction level or other QR/Barcode options (such as, in the example of a BarCode, Code 128, 93, or 39 or in the example of QR Code, different versions (Version 1 (21×21 modules, or blocks) up to Version 40 (177×177 modules, or blocks)).

A PNG or other image format may be generated and sent to the client. The user may receive notice that the ticket has been received.

### Peer-to-Peer Electronic Cash System

As described in the publication “Bitcoin: A Peer-to-Peer Electronic Cash System” authored by Satoshi Nakamoto, a transaction is a unit of data which has been confirmed by a signature, or private key. A private key is a secret number that allows a cryptocurrency unit to be spent. Every cryptocurrency unit address has a matching private key. The private key is mathematically related to the cryptocurrency unit address, and is designed so that the cryptocurrency unit address can be calculated from the private key but, importantly, the reverse cannot be done. The signed data is sent to the peer-to-peer network and contains references to preceding transactions. In more detail, a cryptocurrency unit is defined by a sequence of digitally signed transactions. The owner of a cryptocurrency unit transfers it to the next owner by digitally signing a hash of the previous transaction and the public key of the next owner and adding these to the end of the cryptocurrency unit. A payee may then verify previous transactions to verify the ownership chain. The payee may verify that one of the owners did not double-spend the cryptocurrency unit or did not sign any earlier transactions of that unit. This may be confirmed by a peer-to-peer network in which all nodes are monitoring all transactions. In this way all participants agree on a single history of the order in which all transactions were conducted. The payee needs proof that at the time of each transaction, the majority of nodes agreed it was the first received. This is accomplished via a timestamp.

Servers may publish timestamps and a timestamp server may take a hash of a block of items to be timestamped and widely publish that hash to the network. The timestamp proves that the data must have existed at the time in order to get into the hash. Each timestamp includes the previous timestamp in its hash, forming a chain, with each additional timestamp reinforcing the ones before it. A distributed timestamp server on a peer-to-peer basis uses a proof-of-work system familiar to those familiar with the art.

In a peer-to-peer network, the steps to run the network includes (1) broadcast new transactions to all node in the network; (2) each node in the network collects new transactions into a block; (3) each node in the network works on finding a difficult proof-of-work for its block; (4) when a node in the network finds a proof-of-work, it broadcasts the block to all nodes; (5) nodes in the network accept the block only if all transactions in it are valid and not already spent; and (6) nodes in the network express their acceptance of the block by working on creating the next block in the chain, using the hash of the accepted block as the previous hash. Nodes express their acceptance of the block by working on creating the next block in the chain, using the hash of the accepted block as the previous hash. Nodes always consider the longest chain to be the correct one and will keep working on extending it. New transaction broadcasts do not necessarily need to reach all nodes. As long as they reach more than six nodes, they will get into a block before long.

Payments may be simply verified by keeping a copy of the block headers of the longest proof-of-work chain and may see that a network node has accepted it, and blocks added after it may confirm the network has accepted it. Additional verification may be applied by accepting alerts from network nodes when they detect an invalid block, prompting the client to download the full block and alerted transactions to confirm the inconsistency. Two consecutive SHA-256 hashes are used for transaction verification. RIPEMD-160 is used after a SHA-256 hash for digital signatures or “addresses”.

To allow microtransactions or larger volumes of cryptocurrency units, blockchain transactions contain multiple inputs and outputs. Normally there will be either a single input from a larger previous transaction or multiple inputs combining smaller amounts, and at most two outputs: one for the payment, and one returning the change, if any, back to the Payee.

### Networked Computing Platform

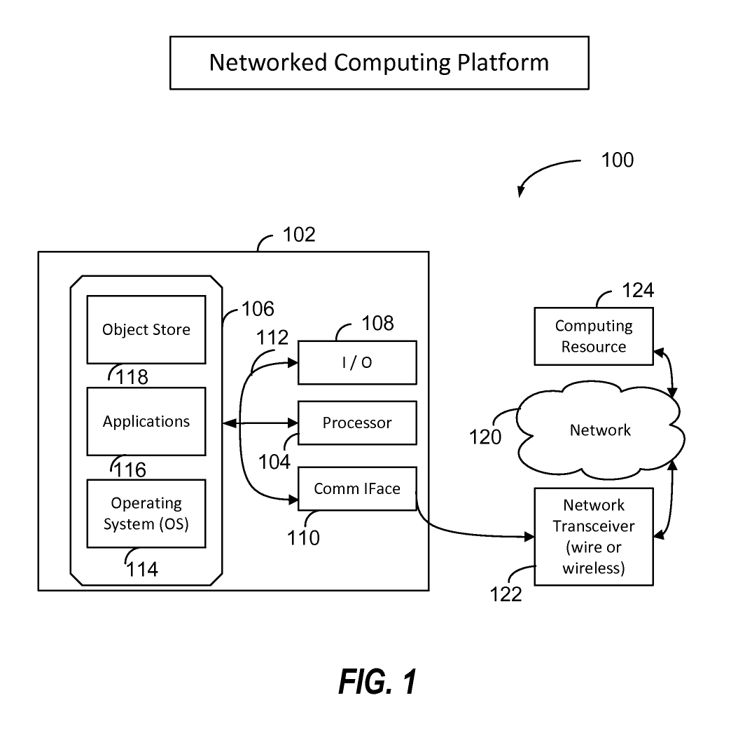

FIG. 1 illustrates an example of a networked computing platform utilized in accordance with an exemplary embodiment. The networked computing platform 100 may be a general mobile computing environment that includes a mobile computing device and a medium, readable by the mobile computing device and comprising executable instructions that are executable by the mobile computing device. As shown, the networked computing platform 100 may include, for example, a mobile computing device 102. The mobile computing device 102 may include a processing circuit 104 (e.g., processor, processing module, etc.), memory 106, input/output (I/O) components 108, and a communication interface 110 for communicating with remote computers or other mobile devices. In one embodiment, the afore-mentioned components are coupled for communication with one another over a suitable bus 112.

The memory 106 may be implemented as non-volatile electronic memory such as random access memory (RAM) with a battery back-up module (not shown) such that information stored in memory 106 is not lost when the general power to mobile device 102 is shut down. A portion of memory 106 may be allocated as addressable memory for program execution, while another portion of memory 106 may be used for storage. The memory 106 may include an operating system 114, application programs 116 as well as an object store 118. During operation, the operating system 114 is illustratively executed by the processing circuit 104 from the memory 106. The operating system 114 may be designed for any device, including but not limited to mobile devices, having a microphone or camera, and implements database features that can be utilized by the application programs 116 through a set of exposed application programming interfaces and methods. The objects in the object store 118 may be maintained by the application programs 116 and the operating system 114, at least partially in response to calls to the exposed application programming interfaces and methods.

The communication interface 110 represents numerous devices and technologies that allow the mobile device 102 to send and receive information. The devices may include wired and wireless modems, satellite receivers and broadcast tuners, for example. The mobile device 102 can also be directly connected to a computer to exchange data therewith. In such cases, the communication interface 110 can be an infrared transceiver or a serial or parallel communication connection, all of which are capable of transmitting streaming information.

The input/output components 108 may include a variety of input devices including, but not limited to, a touch-sensitive screen, buttons, rollers, cameras and a microphone as well as a variety of output devices including an audio generator, a vibrating device, and a display. Additionally, other input/output devices may be attached to or found with mobile device 102.

The networked computing platform 100 may also include a network 120. The mobile computing device 102 is illustratively in wireless communication with the network 120—which may for example be the Internet, or some scale of area network—by sending and receiving electromagnetic signals 299 of a suitable protocol between the communication interface 110 and a network transceiver 122. The network transceiver 122 in turn provides access via the network 120 to a wide array of additional computing resources 124. The mobile computing device 102 is enabled to make use of executable instructions stored on the media of the memory 106, such as executable instructions that enable computing device 102 to perform steps such as combining language representations associated with states of a virtual world with language representations associated with the knowledgebase of a computer-controlled character, in response to an input from a user, to dynamically generate dialog elements from the combined language representations.

### Payment Network—Execution of Financial Transaction

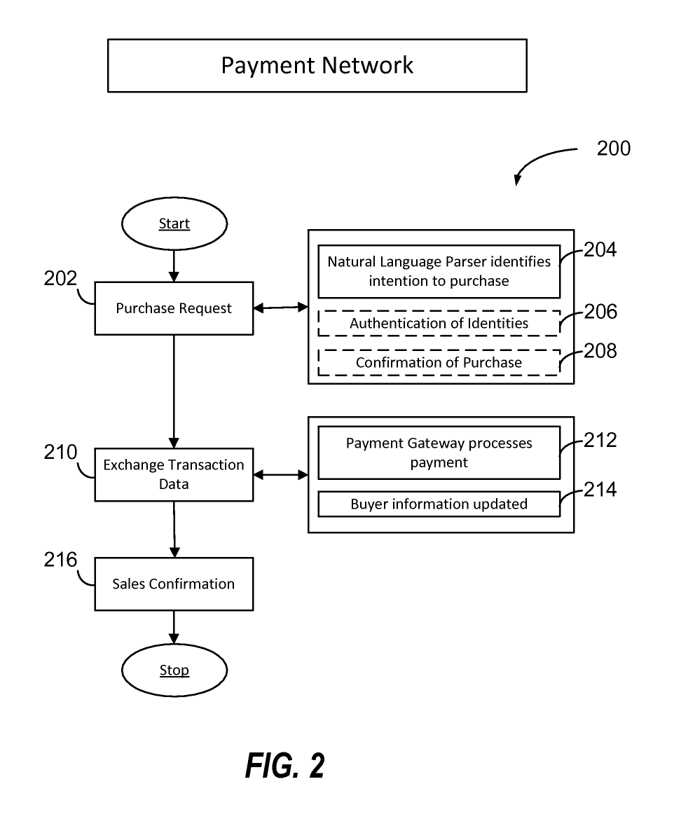

FIG. 2 illustrates a flow chart illustrating of a method of executing a financial transaction, in accordance with an exemplary embodiment. First, a user (or buyer) may make a purchase request using a terminal 202. According to one aspect, a pre-authenticated user may verbally request to execute a financial transaction by speaking into a microphone. Users may be pre-authenticated by any manner known in the art. The microphone may register the voice input causing the terminal to record and save the voice recording. The terminal may then send the voice recording to a voice-to-text module which replies with text input. The text input may then be passed to a natural language processing module which parses the language and identifies the intent of the text 204. Alternatively, the input may be scanned into the terminal or may be a graphic user interface (GUI). Once the intention of the parties has been identified, the identities of the parties may then be authenticated 206. Optionally, the natural language processing (NLP) module may generate a purchase confirmation which is provided to the Buyer 208.

Next, transaction data may be exchanged between the Buyer and Seller 210. The transaction data may include, but is not limited to, purchase requests, authentication of identities, exchange transaction data, and sales confirmations. With regard to purchase requests, the NLP parser may identify the pre-authenticated Consumer/Buyer's intention to make a purchase. A microphone may register the voice input and the terminal may record the voice input and save the voice recording. The voice recording is then sent to a voice-to-text module which replies with text input. The text input is then passed to the NLP module which parses the language and identifies the intent of the voice input of the Consumer/Buyer. Alternatively, other means of input may complement the voice interface such as scanning QR codes and graphical user interface (GUI). With regard to scanning, a QR code on the Consumer/Buyer's mobile device may be read by a machine or conversely, the QR code might be printed out and sitting on a table to be scanned using the Consumer/Buyer's mobile device. With regard to complementary graphical user interface elements, the Consumer/Buyer fills out a form on a display screen and enters information such as the Consumer/Buyer's name, quantities of currency, goods, etc.

Upon the exchange of transaction data, the NLP module may pass this data to a payment gateway application programming interface (API) 212. The payment gateway may process the cryptographically secure payment and generate an invoice status. Next, the Buyer information is updated and the payment details are provided to the Buyer 214.

Next, the payment gateway may confirm the payment and the NLP module may pass the confirmation of the transaction to the terminal 216.

### Distributed Ledger Cryptocurrency Network

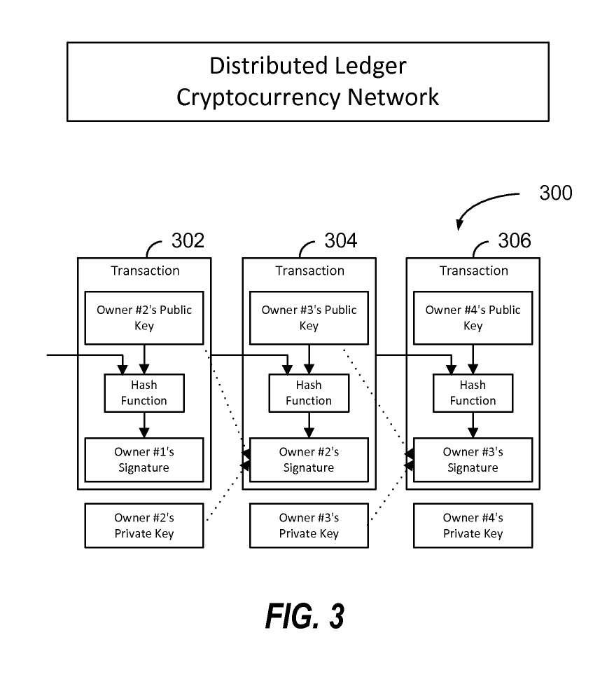

FIG. 3 illustrates an example of a distributed ledger crytpocurrency network 300 utilized in accordance with an exemplary embodiment. Although examples of three transactions 30-306 are shown, this is by way of example only. As described previously, a peer-to-peer network is able to verify transactions via timestamps and cryptographic verification procedures, while simultaneously splitting and combining value in a private system.

According to one example, public-key cryptography may be utilized. With public-key cryptography two separate keys are required. One key is a private key and one key is a public key. Although the two keys are different, the two parts of this key pair are mathematically linked. The public key may be used to encrypt plaintext or to verify a digital signature while the private key may be used to decrypt ciphertext or create a digital signature.

As shown, a first transaction 302 may occur between a first owner and a second owner. A second transaction 304 may occur between the second owner and a third owner. A third transaction 306 may occur between the third owner and a fourth owner.

### Terminal

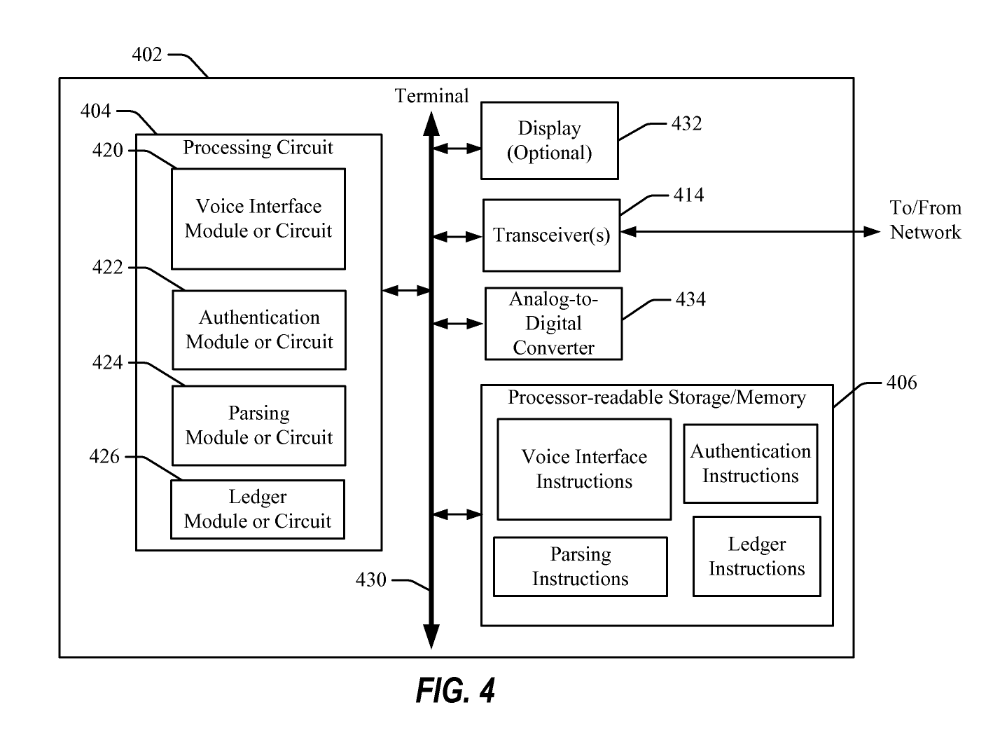

FIG. 4 is a diagram 400 illustrating an example of a hardware implementation for a terminal 402 configured to execute cryptographically secure transactions using voice and natural language processing.

The terminal 402 may include a processing circuit 404. The processing circuit 404 may be implemented with a bus architecture, represented generally by the bus 430. The bus 430 may include any number of interconnecting buses and bridges depending on the application and attributes of the processing circuit 404 and overall design constraints. The bus 430 may link together various circuits including one or more processors and/or hardware modules, processing circuit 404, and the processor-readable medium 406. The bus 430 may also link various other circuits such as timing sources, peripherals, and power management circuits, which are well known in the art, and therefore, will not be described any further.

The processing circuit 404 may be coupled to one or more communications interfaces or transceivers 414 which may be used for communications (receiving and transmitting data) with entities of a network.

The processing circuit 404 may include one or more processors responsible for general processing, including the execution of software stored on the processor-readable medium 406. For example, the processing circuit 404 may include one or more processors deployed in the terminal 102 of FIG. 1. The software, when executed by the one or more processors, cause the processing circuit 404 to perform the various functions described supra for any particular terminal. The processor-readable medium 406 may also be used for storing data that is manipulated by the processing circuit 404 when executing software. The processing system further includes at least one of the modules 420, 422, 424 and 426. The modules 420, 422, 424 and 426 may be software modules running on the processing circuit 404, resident/stored in the processor-readable medium 406, one or more hardware modules coupled to the processing circuit 404, or some combination thereof.

In one configuration, the terminal 402 for wireless communication includes a module or circuit 420 configured to communicate with a consumer interacting (e.g. providing human or natural language input, such as a verbal request) to the terminal 402 and transcribing the natural language input into text, a module or circuit 422 configured to authenticate the consumer interacting with the terminal 402, and a module or circuit 424 configured to parse the text to derive meaning from the natural language input from the authenticated consumer. Optionally, the processing system includes a module or circuit 426 configured to record exchanges of commodities.

In one configuration, the terminal 402 may include an analog-to-digital converter 434. The verbal request may be received by the voice interface module or circuit 420 in the form of an audio frequency signal. The analog-to-digital converter 434 may transform or convert the audio frequency signal into a digital signal. The digital signal may then be parsed using the parsing module or circuit 424 of the processing circuit 404 to identify the intent of the verbal request of the user.

In one configuration, the terminal 402 may optionally include a display or touch screen 432 for receiving and displaying data to the consumer.

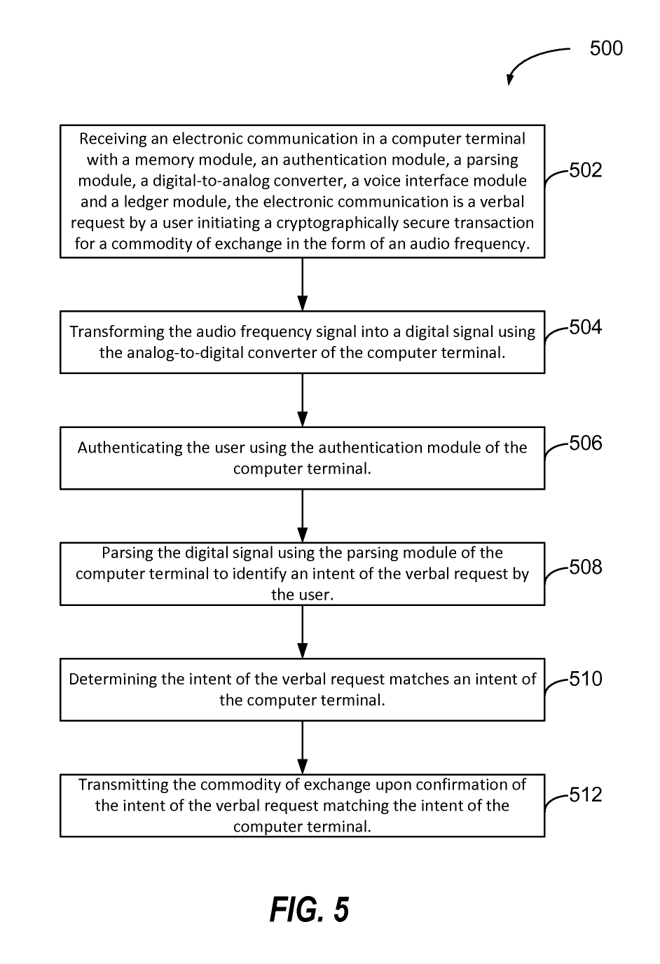

Referring now to FIG. 5, a flow chart is provided to illustrate a computer implemented method 500 for executing cryptographically secure transactions for a commodity of exchange using voice and natural language processing executed on a processor or processing circuit of a computer terminal. First, an electronic communication is received in a computer terminal with a memory module, an authentication module, a parsing module, a digital-to-analog converter, a voice interface module and a ledger module. The electronic communication may be a verbal request by a user initiating a cryptographically secure transaction for a commodity of exchange in the form of an audio frequency signal 502. In addition to or separately, the communication from the user may be in the form of a gesture which may be received by a camera that is in or near the terminal (for example).

Next, the audio frequency signal received in the computer terminal may be transformed into a digital signal using the analog-to-digital converter of the computer terminal 504. Then, the user may be authenticated using the authentication module of the computer 506. The digital signal may then be parsed using the parsing module of the computer terminal to identify an intent of the verbal request by the user 508.

Next, a determination is made that the intent of the verbal request matches an intent of the computer terminal 510. If the intents do not match, the transaction is terminated. Upon receiving confirmation of the intent of the verbal request matching the intent of the computer terminal, the commodity of exchange is transmitted to the user 512.

According to one feature, the method further includes executing on the processor the step of exchanging a digital currency using a ledger module of the computer terminal to complete the cryptographically secure transaction.

According to another feature, the method further includes executing on the processor the step of generating a receipt of the completed cryptographically secure transaction in the form of a barcode where the barcode is transmitted from the computer terminal to a mobile device of the user. The barcode may be in the form of a QR Code or another other type of barcode described above or known in the art.

Semantic, Biometric, and Cultural Elements

Semantic, biometric, and cultural elements may be extracted from a conversation between a software program (that is the software programmed into a terminal) and a user and these elements may be analyzed as a relational group of vectors to generate reports of emotional content, affect, and other qualities. These dialogue elements are derived from two sources.

First is semantic, which may be gathered from an analysis of natural language dialogue elements via natural language processing methods. This input method measures the words, topics, concepts, phrases, sentences, affect, sentiment, and other semantic qualities. Second is biometric, which may be gathered from an analysis of body language expressions via various means including cameras, accelerometers, touch-sensitive screens, microphones, and other peripheral sensors. This input method measures the gestures, postures, facial expressions, tones of voice, and other biometric qualities. Reports may then be generated that compare these data vectors such that correlations and redundant data give increased probability to a final summary report. For example, the semantic reports from the current state of the conversation may indicate the user as being happy because the phrase “I am happy” is used, while biometric reports may indicate the user as being happy because their face has a smile, their voice pitch is up, their gestures are minimal, and their posture is relaxed.

Third is cultural, which may utilized preprogrammed non-verbal social cues corresponding to the location or country that the terminal is located in as different cultures have different social cues. For example, a person nodding his head up and down can have different meanings depending on the culture. Typically in the United States moving the head up and down means yes, however when in the Middle East, when the person nods the head down, it indicates agreement while nodding the head up means they disagree. In Japan and most of Asia including the Philippines, nodding up-and-down is a way to show that someone is listening and is interested with what you are saying.

When the semantic, biometric and cultural reports are compared there is an increased probability of precision in the final summary report. Compared to only semantic analysis or only biometric analysis (with or without the cultural analysis) which generally show low precision in measurements, enabling a program to dynamically generate these effects increases the apparent emotional intelligence, sensitivity, and communicative abilities in computer-controlled dialogue.

One or more of the components, steps, and/or functions illustrated in the figures may be rearranged and/or combined into a single component, step, or function or embodied in several components, steps, or functions without affecting the operation of the communication device having channel-specific signal insertion. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The terms “machine-readable medium”, “computer-readable medium”, and/or “processor-readable medium” may include, but are not limited to portable or fixed storage devices, optical storage devices, and various other non-transitory mediums capable of storing, containing or carrying instruction(s) and/or data. Thus, the various methods described herein may be partially or fully implemented by instructions and/or data that may be stored in a “machine-readable medium”, “computer-readable medium”, and/or “processor-readable medium” and executed by one or more processors, machines and/or devices.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

While certain exemplary embodiments have been described and shown in the accompanying drawings, it is to be understood that such embodiments are merely illustrative of and not restrictive on the broad application, and that this application is not be limited to the specific constructions and arrangements shown and described, since various other modifications may occur to those ordinarily skilled in the art.

1. A computer implemented method for executing cryptographically secure transactions using voice and natural language processing, comprising executing on a processor the steps of:
receiving an electronic communication in a computer terminal with a memory module, an authentication module, a parsing module, a digital-to-analog converter, a voice interface module and a ledger module, the electronic communication is a verbal request by a user initiating a cryptographically secure transaction for a commodity of exchange in the form of an audio frequency signal;
transforming the audio frequency signal into a digital signal using the analog-to-digital converter of the computer terminal;
authenticating the user using the authentication module of the computer terminal;
parsing the digital signal using the parsing module of the computer terminal to identify an intent of the verbal request by the user;
determining the intent of the verbal request matches an intent of the computer terminal; and
transmitting the commodity of exchange upon confirmation of the intent of the verbal request matching the intent of the computer terminal.

2. The method of claim 1, further comprising executing on the processor the step of exchanging a digital currency using a ledger module of the computer terminal to complete the cryptographically secure transaction.

3. The method of claim 1, further comprising executing on the processor the step of generating a receipt of the completed cryptographically secure transaction in the form of a barcode where the barcode is transmitted from the computer terminal to a mobile device of the user.

4. The method of claim 1, wherein the receipt is a QR code.

5. The method of claim 1, wherein the commodity of exchange is selected from at least one of a good, service and a digital currency.

6. The method of claim 1, wherein the user is authenticated using voice recognition.

7. The method of claim 1, wherein determining the intent of the verbal request comprises:
extracting dialogue elements from the verbal request using the parsing module; and
analyzing the dialogue elements as a relational group of vectors to generate reports of emotional content and affect.

8. The method of claim 7, wherein the dialog elements are derived from at least one of semantic elements, biometric elements and cultural elements.

9. A non-transitory computer-readable medium with instructions stored thereon, that when executed by a processor, perform the steps comprising:
receiving an electronic communication in a computer terminal with a memory module, an authentication module, a parsing module, a digital-to-analog converter, a voice interface module and a ledger module, the electronic communication is a verbal request by a user initiating a cryptographically secure transaction for a commodity of exchange in the form of an audio frequency signal;
transforming the audio frequency signal into a digital signal using the analog-to-digital converter of the computer terminal;
authenticating the user using the authentication module of the computer terminal;
parsing the digital signal using the parsing module of the computer terminal to identify an intent of the verbal request by the user;
determining the intent of the verbal request matches an intent of the computer terminal; and
transmitting the commodity of exchange upon confirmation of the intent of the verbal request matching the intent of the computer terminal.

10. The non-transitory computer-readable medium of claim 9, further comprising performing the step of exchanging a digital currency using a ledger module of the computer terminal to complete the cryptographically secure transaction.

11. The non-transitory computer-readable medium of claim 9, further comprising performing the step of generating a receipt of the completed cryptographically secure transaction in the form of a barcode where the barcode is transmitted from the computer terminal to a mobile device of the user.

12. The non-transitory computer-readable medium of claim 9, wherein determining the intent of the verbal request comprises:
extracting dialogue elements from the verbal request using the parsing module; and
analyzing the dialogue elements as a relational group of vectors to generate reports of emotional content and affect.

13. The non-transitory computer-readable medium of claim 12, wherein the dialog elements are derived from at least one of semantic elements, biometric elements and cultural elements.

14. A computer terminal for executing cryptographically secure transactions using voice and natural language processing, the terminal comprising:
a processing circuit;
a communications interface communicatively coupled to the processing circuit for transmitting and receiving information; and
a memory communicatively coupled to the processing circuit for storing information, wherein the processing circuit is configured to:
receive an electronic communication into a voice interface module within the processing circuit, the electronic communication is a verbal request by the user initiating a cryptographically secure transaction for a commodity of exchange in the form of an audio frequency signal;
transform the audio frequency signal into a digital signal using an analog-to-digital converter communicatively coupled to the processing circuit;
authenticate the user using an authentication module within the processing circuit;
parse the digital signal using a parsing module within the processing circuit to identify an intent of the verbal request by the user;
determine the intent of the verbal request matches an intent of the computer terminal; and
transmit the commodity of exchange upon confirmation of the intent of the verbal request matching the intent of the computer terminal.

15. The computer terminal of claim 14, wherein the processing circuit is further configured to exchange a digital currency using a ledger module within the processing circuit to complete the cryptographically secure transaction.

16. The computer terminal of claim 14, wherein the processing circuit is further configured to generate a receipt of the completed cryptographically secure transaction in the form of a barcode where the barcode is transmitted from the computer terminal to a mobile device of the user.

17. The computer terminal of claim 16, wherein the receipt is a QR code.

18. The computer terminal of claim 14, wherein determining the intent of the verbal request comprises:
extracting dialogue elements from the verbal request using the parsing module; and
analyzing the dialogue elements as a relational groups of vector to generate reports of emotional content and affect.

19. The computer terminal of claim 17, wherein the dialog elements are derived from at least one of semantic elements, biometric elements and cultural elements.

20. The computer terminal of claim 14, wherein the commodity of exchange is selected from at least one of a good, service and a digital currency.
